(19) United States
(12) Patent Application Publication
(10) Pub. No.: US 2010/0109521 A1
(43) Pub. Date: May 6, 2010

(54) QUANTUM DOT ELECTROLUMINESCENT DEVICE

(76) Inventors: San Ming Yang, Troy, NY (US); Luis A. Sanchez, Albany, NY (US)

Correspondence Address: HOFFMAN WARNICK LLC, 75 STATE STREET, 14TH FLOOR, ALBANY, NY, 12207, US

(21) Appl. No.: 12/582,793

(22) Filed: Oct. 21, 2009

Related U.S. Application Data
(60) Provisional application No. 61/107,005, filed on Oct. 21, 2008.

(51) Int. Cl. H01J 1/62; H01J 9/22

(52) U.S. Cl. 313/509; 445/23

(57) ABSTRACT

An EL device is presented which consists of a simple three active layer construction. A layer of a dielectric material, a traditional EL phosphor layer, and a quantum dot layer are present between an electrode and a transparent electrode. The EL device is operated efficiently by an AC source. Quantum dots which emit in the visible spectrum are used. The EL device is fully color tunable by altering the composition and thickness of the layers.

### CROSS-REFERENCE TO RELATED APPLICATIONS

The instant application claims the benefit of co-pending U.S. Provisional Patent Application No. 61/107,005, filed 21 Oct. 2008, which is hereby incorporated herein.

### TECHNICAL FIELD

The present invention relates to a novel electroluminescent (EL) device which incorporates semiconductor nanocrystals, or more specifically quantum dots, into an active layer so as to achieve a better color gamut than traditional EL devices.

### BACKGROUND OF THE INVENTION

Thick film electroluminescent (EL) displays have been used in many industries. They were commonly used in many military applications including aviation electronics and vehicle panels. They have also found some use in signage applications and decorative lighting. However, traditional EL phosphors have limited the color range to blue and green in most cases. Some thick film EL devices utilize a cascade energy transfer from an underlying blue phosphor with dyes to produce orange to red light. However, these tend to be far less efficient and less bright than the traditional EL panels. Other EL panels have used combinations of orange and blue phosphors to produce white light, typically also with a low efficiency.

Some EL device designs have used doped quantum dots as a part of the device structure with a direct-current (DC) source. These devices are often inorganic/organic hybrids with electrodes of different work functions and suffer severe drawbacks, including grain boundary issues and oxidation of both the DC electrodes and the doped quantum dots. Doped quantum dots are also more difficult to make and less uniform than those produced by standard quantum dot synthesis.

Semiconductor nanocrystals are typically tiny crystals of II-VI, III-V, IV-VI, or I-III-VI materials that have a diameter between 1 nanometer (nm) and 20 nm. In the strong confinement limit, the physical diameter of the nanocrystal is smaller than the bulk excitation Bohr radius causing quantum confinement effects to predominate. In this regime, the nanocrystal is a 0-dimensional system that has both quantized density and energy of electronic states where the actual energy and energy differences between electronic states are a function of both the nanocrystal composition and physical size. Larger nanocrystals have more closely spaced energy states and smaller nanocrystals have the reverse. Because interaction of light and matter is determined by the density and energy of electronic states, many of the optical and electric properties of nanocrystals can be tuned or altered simply by changing the nanocrystal geometry (i.e. physical size).

Single nanocrystals or monodisperse populations of nanocrystals exhibit unique optical properties that are size tunable. Both the onset of absorption and the photoluminescent wavelength are a function of nanocrystal size and composition. The nanocrystals will absorb all wavelengths shorter than the absorption onset. However, photoluminescence will always occur at the absorption onset. The bandwidth of the photoluminescent spectra is due to both homogeneous and inhomogeneous broadening mechanisms. Homogeneous mechanisms include temperature-dependent Doppler broadening and broadening due to the Heisenberg uncertainty principle, while inhomogeneous broadening is due to the size distribution of the nanocrystals. The narrower the size distribution of the nanocrystals is, the narrower the full-width at half max (FWHM) of the resultant photoluminescent spectra will be. In 1991, Brus wrote a paper reviewing the theoretical and experimental research conducted on colloidally grown semiconductor nanocrystals, such as cadmium selenide (CdSe) in particular. Brus L., Quantum Crystallites and Nonlinear Optics, Applied Physics A, 53 (1991)). That research, precipitated in the early 1980's by the likes of Efros, Ekimov, and Brus himself, greatly accelerated by the end of the 1980's as demonstrated by the increase in the number of papers concerning colloidally grown semiconductor nanocrystals in past years.

There remains a need for a simple design EL device capable of a wide color gamut and high efficiencies, preferably which can be operated on an alternating-current (AC).

### SUMMARY OF THE INVENTION

In one embodiment of the present invention, an EL device consists of a simple three active layer construction. A layer of a dielectric material, a traditional EL phosphor layer, and a quantum dot layer are present between an electrode and a transparent electrode. The EL device is operated efficiently by an AC source. In this case quantum dots which emit in the visible spectrum are used. The EL device is fully color-tunable by altering the composition and/or thickness of the layers.

Alternatively, quantum dots of near infrared or infrared emission may be used in the same structure, with an optional filter to absorb visible light placed on the adjacent side of the transparent electrode, so as to emit no visible light.

Another embodiment of the present invention includes a method of fabricating an EL device capable of operating on an AC source and emitting specific colors.

The semiconductor nanocrystals, or quantum dots more specifically, useful in the present invention are described in the commonly-owned application Ser. Nos. 11/125,120 and 11/125,129. These quantum dots comprise a core semiconductor with a thin metal layer to protect from oxidation and to aid in lattice matching, and a shell to enhance the luminescent properties, especially for the II-VI or III-V materials. Non-limiting examples of semiconductor nanocrystal cores include ZnS, ZnSe, ZnTe, CdS, CdSe, CdTe, HgS, HgSe, HgTe (II-VI materials), PbS, PbSe, PbTe (IV-VI materials), AIN, AlP, AlAs, AlSb, GaN, GaP, GaAs, GaSb, InN, InP, InAs, InSb, InGaP (III-V materials), CuInGaS₂, CuInGaSe₂, AgInS₂, AgInSe₂, and AuGaTe₂ (I-III-VI materials). The metal layer is often formed of Zn or Cd, and the shell may be of the same material as the core or any of the above listed core materials.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows the structure of and EL device according to an embodiment of the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

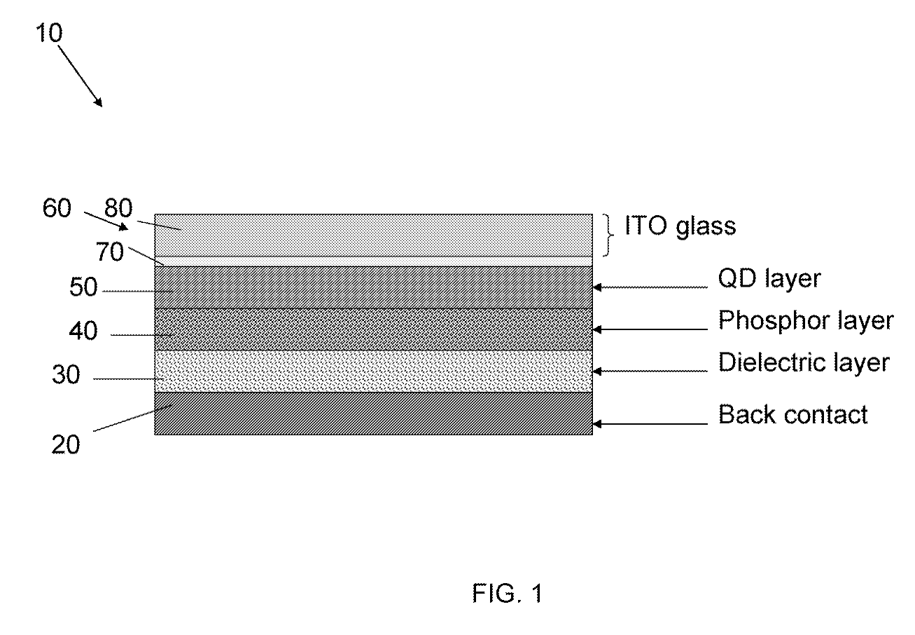

An EL device (10) according to an embodiment, as depicted in FIG. 1, comprises a back contact (20), which serves as an electrode. A dielectric layer (30) is disposed over the back contact (20), with a traditional phosphor active layer (40) above the dielectric layer (30) and a quantum dot active layer (50) stacked above the phosphor active layer (40). On the other side of the quantum dot layer (50) is placed an indium tin oxide (ITO) coated piece of glass (60).

The back contact (20) acts as the non-transparent electrode, the back side of the EL device. In some embodiments, it consists of either a silver or carbon conductive paste, which can easily be spin-coated, blade-coated, or screen-printed onto a surface. In some embodiments, it is coated onto another piece of glass or plastic, so as to produce a flexible EL device. The front contact, ITO glass (60), is commercially available from many companies and includes optically transparent glass (80) with a very thin coat of indium tin oxide (70), usually having been spin-coated onto the glass.

The dielectric layer (30) typically includes a dispersion of a high dielectric material. In one embodiment, barium titanate (BaTiO₃) or titanium dioxide (TiO₂) is used. In some embodiments, a single dielectric layer is used, which reduces the cost of manufacturing, as some of the EL devices produced previously used two or more dielectric layers. The phosphor layer (40) includes a dispersion of a commercially-available inorganic EL phosphor. In some embodiments, the phosphor is a blue phosphor, such as GG65, available from OSRAM-Sylvania. The quantum dot layer (50) includes a dispersion of quantum dots, such as a semiconductor nanocrystal core with a metal layer and a shell with a high quantum yield. A monodispersion of a single size distribution of quantum dots of the same material may be used for a specific color. Alternatively, multiple size distributions and/or quantum dot materials may be used for white light or more complex EL devices, including custom or multiple color EL devices.

The quantum dot layer (50), phosphor layer (40), and the dielectric layer (30) may be prepared by dispersing the components of each into the same high dielectric polymer or resin. In some embodiments, this polymer or resin may include electrically conductive polyvinyl fluoride (ECPVF), polyvinyl difluoride (PVDF), or cyanoresin. The quantum dot layer (50) may be coated onto the ITO glass. The phosphor/polymer mixture can then be coated over the quantum dot layer (50). The dielectric/polymer can then be coated onto the phosphor/polymer layer. The back contact may then be coated onto the dielectric layer, with an additional piece of glass or plastic attached to the back contact in some embodiments. Each of these layers may be coated using techniques well known in the art, namely but not limited to spin-coating, blade-coating, and screen-printing. Inconsistencies in the coating will result in inconsistent light output. Thus, the more uniform the coating, the better the resulting device will be. As would be clear to one skilled in the art, any now-known or later-developed coating techniques could be used without altering the spirit of the invention.

The EL device of the current invention is capable of being operated by an AC source running from about 80 V to about 400 V at between about 100 Hz and about 1000 Hz.

An advantage of this device structure is that the voltage applied to the EL device excites the traditional EL phosphor, resulting in a blue light emission, or other color, depending upon the EL phosphor used. This emission then excites the quantum dots in the quantum dot layer, causing the layer to absorb at least a portion of the phosphor emission and re-emit the light at the wavelength of the quantum dot emission profile. Voltage leaks that are not absorbed by the phosphor layer may also serve to excite the quantum dots and result in primary emission. By varying the thickness and concentration of the quantum dot layer, as well as the size distribution and materials of the quantum dots, more or less of the underlying phosphor light emission may mix with the quantum dot emission, allowing for more variations in the possible colors by EL devices according to the invention. More than a single population of quantum dots may be used, or the color of the underlying phosphor may be changed to achieve nearly any color of light.

In an alternative embodiment, quantum dots which emit in the near infrared (NIR) to infrared (IR) spectrum may be used, such as the previously mentioned IV-VI materials. In this case, the quantum dots still absorb light from the phosphor and re-emit NIR or IR light. To obtain a more covert device, an optional filter may be added outside of the electrodes, preferably on top of the ITO glass. The optional filter is able to absorb visible light which may bleed through the quantum dot layer (50). Many such filters are known in the art, and one skilled in the art would recognize that different types of filters could be chosen, and may absorb some or all of the visible light. Filters may also be chosen to allow all or some portion of NIR or IR light to pass through as well. In such an embodiment, EL devices which emit a narrow IR spectrum could be produced. These types of EL devices may be advantageously brighter and easier to build than some previous devices, such as the commonly-owned application Ser. No. 12/048,061 with a NIR or an IR filter comprising quantum dots placed over a preexisting EL device, rather than being incorporated as an active layer of the EL device as in the current invention.

Below are provided an example of an embodiment of the invention and methods useful in practicing various embodiments of the invention.

### Example 1

First, a small piece of ITO glass is obtained, the ITO glass being about the same size as a microscope slide. A quantum dot dispersion in ECPVF is prepared by mixing 100 mg of 625 nm emitting CdSe/ZnS quantum dots (previously synthesized) per 1 mL of ECPVF. The resulting 100 mg/mL dispersion is blade-coated onto the ITO glass. Next, GG65 phosphor from OSRAM-Sylvania is mixed with ECPVF to a concentration of 100 mg/mL and blade-coated onto the quantum dot layer. BaTiO₃ is combined with ECPVF to a concentration of 50 mg/mL and blade-coated onto the phosphor layer. A silver conductive paste is then blade coated onto a piece of glass, which is pressed onto the BaTiO₃ layer with a wire connected. The wire from the back contact and a wire attached to the ITO glass are connected to a power source and results in a red-emitting EL panel.

The foregoing description of various aspects of the invention has been presented for the purpose of illustration and description. It is not intended to be exhaustive or to limit the invention to the precise form disclosed, and obviously, many modifications and variations are possible. Such variations and modifications that may be apparent to one skilled in the art are intended to be included within the scope of the present invention as defined by the accompanying claims.

What is claimed is:

1. An electroluminescent device comprising:
a high dielectric layer;
an electroluminescent phosphor layer; and
a quantum dot layer.

2. The device of claim 1, wherein each of the high dielectric layer, the electroluminescent phosphor layer, and the quantum dot layer includes at least one of the following: a high dielectric polymer or a high dielectric polymer resin.

3. The device of claim 1, wherein the high dielectric layer includes at least one dielectric selected from a group consisting of: BaTiO₃ and TiO₂.

4. The device of claim 1, wherein the electroluminescent phosphor layer includes at least one electroluminescent phosphor selected from a group consisting of: a blue-emitting phosphor, a blue-green-emitting phosphor, a green-emitting phosphor, and combinations thereof.

5. The device of claim 1, wherein the quantum dot layer includes at least one quantum dot selected from a group consisting of: group II-VI materials, III-V materials, IV-VI materials, I-III-VI materials, and combinations thereof.

6. An electroluminescent display comprising:
a first electrode;
a high dielectric layer disposed atop the first electrode;
an electroluminescent phosphor layer atop the dielectric layer;
a quantum dot layer disposed atop the electroluminescent phosphor layer; and
a second electrode atop the quantum dot layer.

7. The electroluminescent display of claim 6, wherein the first electrode includes glass coated with at least one conductive material selected from a group consisting of: a silver conductive paste and a carbon conductive paste.

8. The electroluminescent display of claim 6, wherein the second electrode includes glass coated with indium tin oxide (ITO).

9. The electroluminescent display of claim 6, wherein the high dielectric layer includes at least one dielectric selected from a group consisting of: BaTiO₃ and TiO₂.

10. The electroluminescent display of claim 6, wherein the electroluminescent phosphor layer includes at least one electroluminescent phosphor selected from a group consisting of: a blue-emitting phosphor, a blue-green-emitting phosphor, a green-emitting phosphor, and combinations thereof.

11. The electroluminescent display of claim 6, wherein the quantum dot layer includes at least one quantum dot selected from a group consisting of: group II-VI materials, III-V materials, IV-VI materials, I-III-VI materials, and combinations thereof.

12. The electroluminescent display of claim 6, wherein at least one of the first electrode and the second electrode is flexible.

13. A method of forming an electroluminescent device, the method comprising:
applying to a piece of indium tin oxide (ITO)-coated glass a quantity of quantum dots;
depositing a quantity of an electroluminescent phosphor atop the quantum dots;
depositing a quantity of a high dielectric material atop the electroluminescent phosphor; and
applying a conductive-coated glass to the high dielectric material.

14. The method of claim 13, further comprising:
connecting a conductive wire to each of the ITO-coated glass and the conductive-coated glass.

15. The method of claim 13, wherein the conductive-coated glass includes at least one conductive material selected from a group consisting of: a silver conductive paste and a carbon conductive paste.

16. The method of claim 13, wherein the high dielectric material includes at least one dielectric selected from a group consisting of: BaTiO₃ and TiO₂.

17. The method of claim 13, wherein the electroluminescent phosphor is selected from a group consisting of: a blue-emitting phosphor, a blue-green-emitting phosphor, a green-emitting phosphor, and combinations thereof.

18. The method of claim 13, wherein the quantum dots are selected from a group consisting of: group II-VI materials, III-V materials, IV-VI materials, I-III-VI materials, and combinations thereof.
